(19) United States
(12) Patent Application Publication
(10) Pub. No.: US 2003/0039241 A1
(43) Pub. Date: Feb. 27, 2003

(54) Telephone number domain name system and operating method thereof on internet

(76) Inventors: Mi-Ryong Park, Daejeon (KR); Joo-Myoung Seok, Daejeon (KR); Chang-Min Park, Daejeon (KR); Jong-Hyup Lee, Daejeon (KR); Kyou-Ho Lee, Daejeon (KR); Hyeong-Ho Lee, Daejeon (KR)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 09/998,571

(22) Filed: Nov. 16, 2001

(30) Foreign Application Priority Data
Aug. 23, 2001 (KR) 2001-51197

(51) Int. Cl. H04L 12/66; H04J 3/16

(52) U.S. Cl. 370/352; 370/466

(57) ABSTRACT

A telephone number domain name system is provided for managing a telephone number system using an existing domain name system thereby allowing a telephone number to be unique worldwide. The system includes a telephone number domain name system client and telephone number domain name server. The telephone domain name client includes a telephone number input section for receiving a telephone number, a domain name conversion section for converting the telephone number into a domain name, and an address request section for requesting an Internet protocol (IP) address corresponding to the converted domain name. The telephone number domain name server includes an address search section for searching an Internet protocol (IP) address corresponding to the request, and an address response section for transmitting a searched Internet protocol address to the address request section.

### BACKGROUND OF THE INVENTION

1. Field of the Invention

The present invention relates to a telephone number domain name system and operating method thereof on the Internet, and more particularly to a telephone number domain number system and operating method thereof on the Internet, which can integrate the Internet and public switched telephone networks and provide communication services through the integrated networks.

2. Background of the Invention

The Internet is becoming an integral part of human lives. A variety of efforts have been continuously made to rapidly provide accurate information through the Internet.

A variety of data are distributed through the Internet, which is called the thesaurus of information. The Internet includes a large number of virtual spaces, which are called Web sites. Additionally, the Internet has been further developed with the development of various communication networks. Nowadays, Public Switched Telephone Networks (PSTN), each having a large number of lines exists all over the world as well as in Korea.

With the increase of the human desire for convenience and the development of information technology, attempts to effectively utilize the Internet have been made. One of the attempts is to conveniently utilize telephones, which are main communications means of human being, on the Internet. The principal examples of such an attempts are communications services, such as ‘Internet Phone’ or ‘Dial Pad’. In these communication services, telephone connections are performed by clicking a previously inputted or registered telephone numbers, by using a wide range of communication paths and a their own programs.

In order to provide Voice over Internet protocol (VoIP) services on the Internet, the Telecommunications Standardization Sector of the International Telecommunication Union (ITU-T) standardized the H.323 protocol and the Internet Engineering Task Group (IETF) standardized the Session Initiation Protocol (SIP). The two protocols are widely used on customer premises networks, and expected to be parts of Internet applications most widely used in the future. However, the two methods use a variety of terminal identifiers such as existing telephone numbers (E.164), domain names, electronic mail addresses, etc. So, in order to make a mapping with Internet addresses, the H.323 protocol and the SIP protocol employ a gatekeeper and a location server, respectively. The end terminals of the two protocols establish interconnection in such a way that the identifiers of the end terminals are recognized by registration on the gate keeper and the location server, destination identifiers are requested from servers and the end terminals are interconnected with each other using the Internet addresses of the destination end terminals. As networks become complicated and end terminals are diversified, a complicated interconnection is created between servers and excessive effort is needed to interconnect the two protocols.

Typically, there has been disclosed the method that a company or an individual's phone is registered on a Web browser, so a telephone or mobile phone is connected to the company or individual's homepage. However, in the conventional method does not employ the technique in that telephone number of a terminal is directly resolved into a domain name and an Internet Protocol (IP) address corresponding to the domain name is searched for, but application technique between a client and a Web server. Meanwhile, there has been disclosed an interconnecting method between a telephone terminal and a domain name system (DNS), but there is not disclosed a method for resolving a terminal telephone number into a domain name using an existing DNS so as to connect PSTNs and the Internet to each other and directly connect telephone terminals by using various protocols to each other, and client and server for the method.

FIG. 1 shows a typical diagram illustrating the conventional interconnection of the Internet and PSTNs for providing VoIP services. The interconnection has been established based on standard protocols for VoIP services, that is, H.323 and SIP protocols. As shown in FIG. 1, the network using the H.323 protocol is illustrated as a H.323 network 120 and the network using the SIP protocol is illustrated as a SIP network 130.

In the H.323 network 120, an H.323-based telephone 123, an H.323-based facsimile 124 and an H.323-based personal data assistant (PDA) are connected to a gate keeper 122 and a media gateway 121 is provided to connect the H.323 network to an existing PSTN 110. The existing PSTN 110 is a hybrid network in which a telephone 111 and a facsimile 113 are connected to a private branch exchange (112; PBX).

In the SIP network 130, a SIP-based telephone 135, a SIP-based facsimile 134 and a SIP-based PDA 133 are connected to a proxy server 132 to resister on a location server 131 and a media gateway 136 is provided to connect the SIP network to an existing PSTN 140. The existing PSTN 140 is a hybrid network in which a telephone 142 and a facsimile 143 are connected to a private branch exchange (141; PBX).

The H.323 network 120 and the SIP network 130 are not connected to each other, and independent services are each provided within each protocol.

In the conventional VoIP services, H.323 and SIP protocols are independent registration services using gate keepers and location servers, so connected end terminals can be distinguished by their identifiers and a connecting services are established between end terminals on the basis of source and destination addresses.

However, in the conventional arts, there is no provision for a direct connecting channel. Accordingly, interconnectivity is deteriorated, complexity is increased due to intercommunications through multistage connection and address acquisition, and delay in call connection is augmented. In addition, there is inconvenience that servers should be managed by organizations and different servers should be operated according to protocols.

In addition, in the US patent (U.S. Pat. No. 6,201,965), there is a method for providing a communication between a mobile terminal each other by using DNS. However, there is not a method for converting a telephone number into IP and transmitting it by using a telephone number DNS.

Furthermore, in the US patent (U.S. Pat. No. 6,243,749), there is a method for providing an IP address updating by using a registration and deletion function. However, there is not a method for searching and converting a domain name by using telephone number DNS.

### SUMMARY OF THE INVENTION

The present invention relates to a telephone number domain name system and operating method thereof on the Internet, and more particularly to a telephone number domain number system and operating method thereof on the Internet, which can integrate the Internet and public switched telephone networks and provide communication services through the integrated networks.

In addition, the present invention provides a telephone number domain name system and operating method thereof on the Internet, which is capable of managing a telephone number system using a existing domain name system being used on the Internet, thereby allowing a telephone number to be unique worldwide.

According to the present invention, the present invention provides a telephone number domain name system on the Internet network, providing a connection between IP address and telephone number on the Internet network offering Voice over Internet Protocol (VoIP) services and being connected to Public Switched Telephone Network (PSTN), comprising a client and a telephone number domain server. The client includes a telephone number input section for receiving a telephone number, a domain name conversion section for converting said received telephone number into a domain name, and an address request section for requesting an Internet protocol (IP) address corresponding to said converted domain name. And the telephone number domain server includes an address search section for searching an IP address corresponding to an IP address request of said address request section, an address response section for transmitting said searched IP address to said client

In addition, the present invention provides an operating method of a telephone number domain name system on the Internet, said telephone number DNS including a plurality of telephone terminal clients and a plurality of servers for processing said client's requests, said telephone terminal clients and servers being connected through one or more public switched telephone networks (PSTNs) and the Internet to provide Voice over Internet Protocol (VoIP) services, comprising the steps of inputting a destination telephone number to a client, converting said inputted telephone number into a domain name, requesting an IP address corresponding to said converted domain name from one or more servers, searching for said requested IP address, and transmitting said searched IP address to said client.

### BRIEF DESCRIPTION OF THE DRAWINGS

FIG. 1 is a diagram showing the conventional interconnection of server the Internet and PSTNs for providing VoIP services.

FIG. 2 is a diagram showing the construction of a telephone number domain name system in accordance with the present invention.

FIG. 3 is a diagram showing the hierarchical construction of the telephone number DNS of the present invention.

FIG. 4 is a flowchart showing the operation of the telephone number DNS server of the present invention.

FIG. 5 is a flowchart showing the operation of the telephone number DNS server.

FIG. 6 is a flowchart showing the process of resolving a telephone number into a domain name.

FIGS. 7a to 7c are tables showing an example of the process of resolving a telephone number into a domain name shown in FIG. 6.

FIG. 8 is a flowchart showing the process of resolving a telephone number URL into a domain name.

FIGS. 9a to 9c are tables showing an example of the procedure of resolving a telephone number URL into a domain name.

### DESCRIPTION OF THE PREFERRED EMBODIMENT

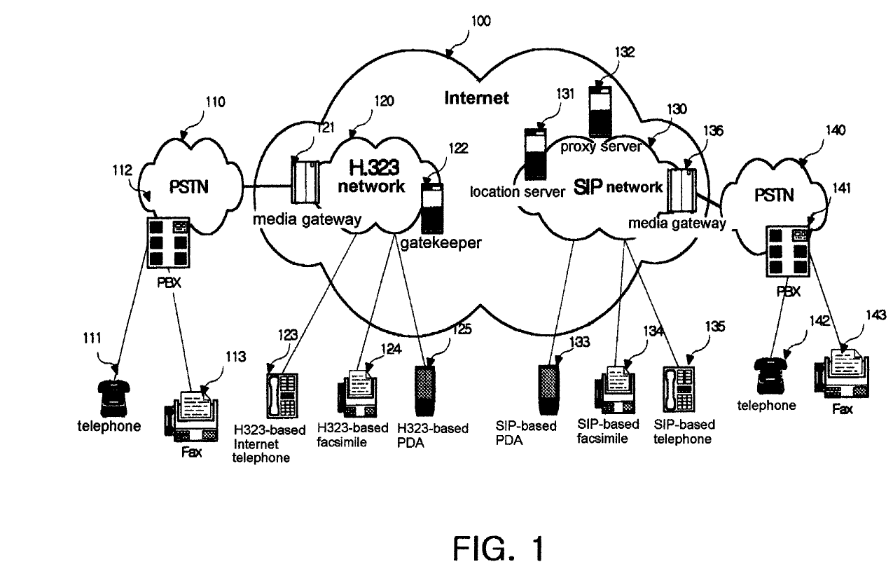

The present invention can be best understood with reference to FIGS. 1˜9.

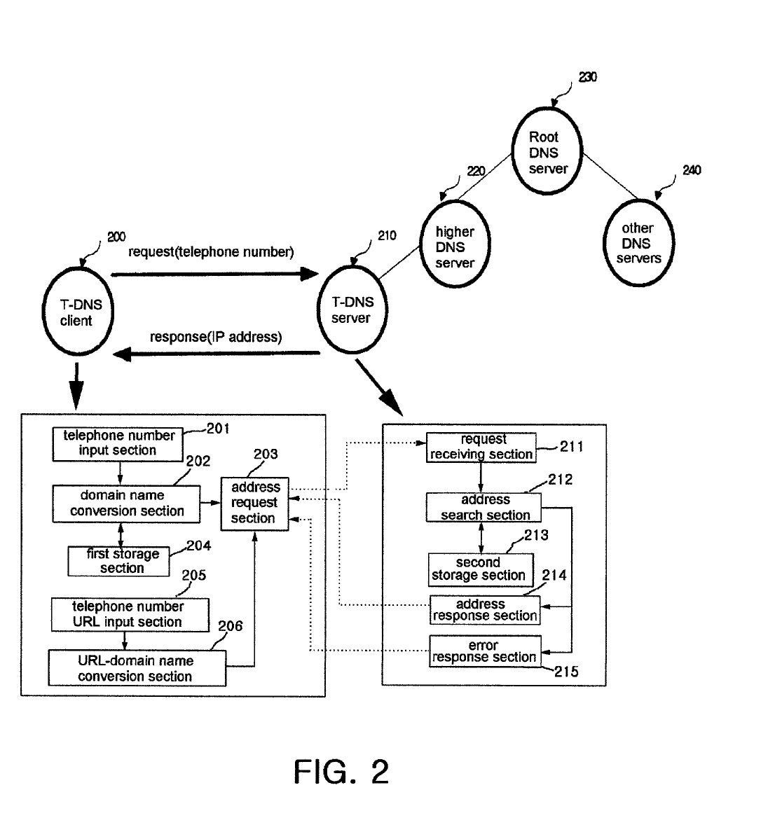

FIG. 2 is a diagram showing the overall structure of a telephone number DNS in accordance with the present invention, which illustrates the telephone number DNS constituting a client/server architecture. As shown in FIG. 2, the telephone number DNS is comprised of a telephone number DNS client 200 and a telephone number DNS server 210 like a conventional DNS. For the domain name not existing in the telephone number DNS server 210, a destination telephone name can be resolved into an IP address while servers are searched for the domain name in order of a root DNS server 230 to lower serves.

As shown in FIG. 2, the telephone number DNS of the present invention allows telephone numbers to be registered as domain names without change of an existing DNS. The telephone number DNS includes the telephone number domain client 200 and the telephone number DNS server 210 to provide a domain name management service for a telephone number system. The telephone number DNS client and server allows a destination IP address to be easily obtained on the basis of a destination telephone number through their operations and processing procedures, and, conversely, a destination telephone number to be easily obtained on the basis of a destination IP address.

In order to provide a telephone DNS service on a media gateway that connects to the PSTN intelligent Internet telephones and general Internet telephones to which Uniform Resource Locator (URL) information can be input, the telephone number DNS client 200 is required.

The telephone number DNS client 200 comprises a telephone number input section 201 for receiving a telephone number inputted by a user, a domain name conversion section 202 for converting the inputted telephone number into a domain name, a first storage section 204 for storing and managing domain name cache information, and an address request section 203 for requesting an IP address corresponding to the formed fully qualified domain name (FQDN) from the telephone number DNS server 210 if the FQDN is formed as a result of the conversion of the telephone number-into-the domain name.

Additionally, the telephone number DNS client 200 further comprises a telephone number URL input section 205 for receiving a telephone number URL inputted by a user if the telephone number DNS client 200 is able to use URLs, and a telephone number URL-into-domain name conversion section 206 for resolving a telephone number URL inputted through the telephone number URL input section 205 into a domain name so as to find a destination IP address on the basis of the inputted telephone number URL.

The telephone number DNS server 210 has the same construction and operation as a currently utilized DNS server. The servers 210 are arranged by regions on the basis of E.164 telephone numbers and are always waiting on background. The telephone number DNS server 210 waiting for client's requests comprises a request receiving section 211 for receiving an IP address request transmitted from a client, an address search section 212 for searching an IP address corresponding to the IP address request, a second storage section 213 for storing and managing IP address cache information, an address response section 214 for transmitting a searched IP address to the address request section 203 of the telephone number DNS server 210, and an error response section 215 for transmitting an error message to the address request section 203 of the telephone number DNS server 210 when a response is impossible or the requested IP address does not exist.

The first storage section 204 and the second storage section 213 store and manage searched or utilized domain names and IP addresses, respectively. The domain name conversion section 202 searches the first storage section 204 for a domain name corresponding to the inputted telephone number, and converts the inputted telephone number into a domain name corresponding to the inputted telephone number using a pre-established program. In a similar manner, when an IP address is requested by the telephone DNS client 200, the address search section 212 searches the second storage section 204 for an IP address corresponding to the inputted domain name and searches the telephone number DNS server, or a higher DNS server 220 for an IP address corresponding to the inputted domain name if a desired IP address does not exist in the second storage section 213.

The domain name conversion section 202 stores a once used domain name in the first storage section 204, and allows the once used domain name to be used again through the search of the second storage section 213.

The operations of the telephone number DNS client 200 and server 210 are described, hereinafter. First of all, in the telephone number DNS client 200, a desired destination telephone number is inputted through the telephone number input section 201 by a user, and the inputted destination telephone number is converted into a FQDN by the domain name conversion section 202. In this case, if the converted FQDN exists in the first storage section 204 serving to store and manage domain name cache information, the corresponding FQDN is retrieved. The address request section 203 requests the IP address corresponding to the converted FQDN from its basic domain server, that is, the telephone DNS server 210.

When the request receiving section 211 receives the IP address request from the telephone number DNS client 200, the address search section 212 searches the IP address cache information stored in the second storage section 213 for the IP address corresponding to the inputted domain name, or servers for the IP address if the IP address does not exist in the second storage section 213. In this case, the address search section 212 first searches its own telephone number DNS server 210, and the root DNS server 230 and the higher DNS server 220 if the IP address does not exist.

As a result of the search, if the IP address exists, the telephone number DNS server 210 transmits a response to the telephone number DNS client 200 through the address response section 214; if the IP address does not exist, an error message is transmitted to the telephone number DNS client 200 through the error response section 215.

Although a telephone number is converted into an IP address in the above description of the operation, an IP address can be converted into a telephone number.

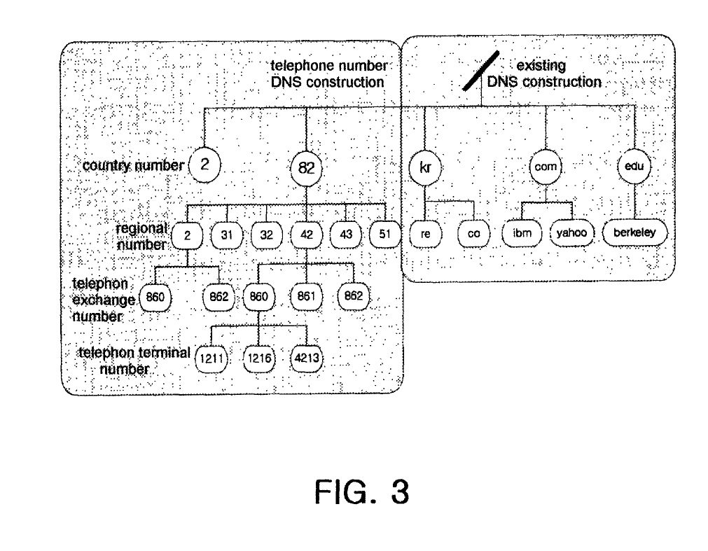

FIG. 3 is a diagram showing the hierarchical construction of the telephone number DNS of the present invention, which illustrates an example of the construction of the telephone number DNS. The telephone number DNS is principal information that the telephone number DNS server 210 should have, and is constructed to fit an existing telephone number system. On the Internet, a domain consists of a set of network addresses and is organized in levels. The top level domain identifies a nation, or purpose commonality within U.S. The second level domain identifies a unique place within the top level domain and is, in fact, equivalent to a unique address on the Internet. Lower level domains may also be used. A general telephone number consists of a nation number unique to each nation, a regional number unique to each region, a telephone exchange number unique to each telephone station, and a telephone terminal number unique to each telephone end terminal. As shown in FIG. 3, when the telephone number DNS is adapted to an existing DNS, the nation code of the telephone number can be the top level domain because the nation codes are different from each other by nations. For example, Korea forms a top level domain “82”, which corresponds to “kr” or “com” domain of the existing DNS. Additionally, the domain management server of the top level domain “82” has information about regional code domain management servers. For example, Seoul forms a second level domain “2”, which corresponds to “re” or “co” domain of the existing DNS. The regional number domain management servers have information about telephone exchange number domain management servers. The telephone exchange number domain management servers directly manage terminal telephone numbers, and can handle conversion between a telephone number and an IP address.

The telephone number DNS client of the present invention can be comprised of an intelligent server, and follows a unified telephone number denotation system. In the unified telephone number denotation system, both telephone number URL and telephone numbers themselves can be employed.

A telephone number can be represented as a telephone number URL, for example, “phone:+82-42-860-1211” or “sip:0428601211@gateway”, and used on an intelligent end terminal. The intelligent end terminal converts the represented telephone number URL into a FQDN, for example, “1211.860.42.82”, that can be recognized by the telephone number DNS, and requests the resolved FQDN from a domain name server. A general client can convert a telephone number to a FQDN by inputting the telephone number and find an Internet address through domain name servers by using resolved FQDN, so source and destination telephone numbers and IP addresses can be easily acquired and connection between end terminals is easily performed.

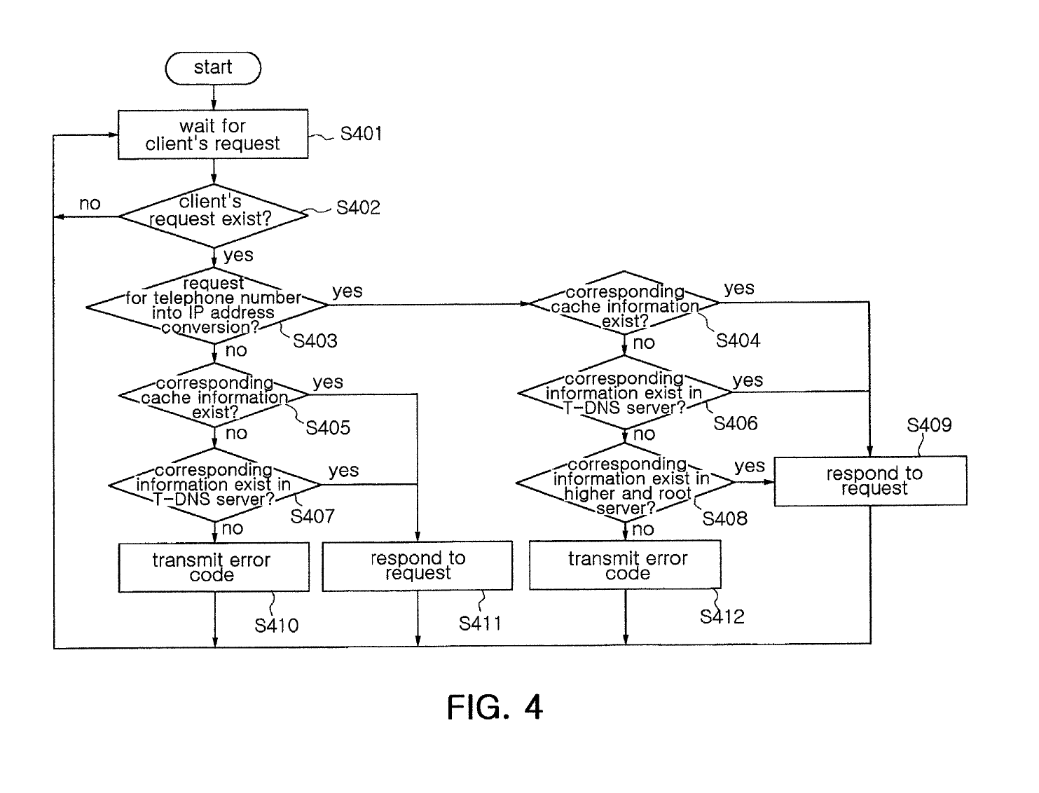

FIG. 4 is a flowchart showing the operation of the telephone number DNS server of the present invention, which illustrates the operation and processing procedure of the telephone number DNS server 210 for providing information possessed by the telephone number DNS server 210. The telephone number DNS server 210 of the present invention can convert telephone numbers into IP addresses while maintaining the existing DNS and transmit a telephone number to the IP address, since the telephone number DNS server 210 has the same construction and information as the existing DNS server.

First of all, the telephone number DNS server 210 is kept waiting for responding to the requests of the telephone number DNS client 210 (S401). If the telephone number DNS client 210 requests conversion between a telephone number and an IP address (S402), the telephone number DNS server 210 determines whether the request is to convert a telephone number into an IP address or an IP address into a telephone number (S403). If the request is to convert a telephone number into an IP address, it is determined whether previously found (preset) IP address cache information corresponding to the inputted telephone number exists (S404). If the cache information corresponding to the inputted telephone number exists, the IP address corresponding to the input telephone number is transmitted to the telephone number DNS client 200 (S409). If the cache information corresponding to the inputted telephone number does not exist, it is determined whether the IP address information corresponding to the inputted telephone number exists in the telephone number DNS server 210 (S406). If the IP address information corresponding to the inputted telephone number exists in the telephone number DNS server 210, the IP address corresponding to the inputted telephone number is transmitted to the telephone number DNS server 210 (S409). If the IP address information corresponding to the inputted telephone number does not exist in the telephone number DNS server 210, it is determined whether the IP address information corresponding to the inputted telephone number exists in the higher server 230 (S408). If the IP address information corresponding to the inputted telephone number exists in the higher server 230, the IP address corresponding to the inputted telephone number is transmitted to the telephone number DNS client 200 (S409). If the IP address information corresponding to the inputted telephone number does not exist in the higher server 230, an error message is transmitted to the telephone number DNS client 200 (S412).

However, if, at step S403, the telephone number DNS server 210′ s request is to convert an IP address into a telephone number, it is determined whether the telephone number cache information corresponding to the inputted IP address exists in the telephone number DNS server 210 (S405). If the cache information corresponding to the inputted IP address exists in the telephone number DNS server 210, the telephone number corresponding to the inputted IP address is transmitted to the telephone number DNS client 200 (S411) If the cache information corresponding to the inputted IP address does not exist in the telephone number DNS server 210, it is determined whether the telephone number information corresponding to the inputted IP address exists in the telephone number DNS server 210 (S407).If the telephone number information corresponding to the inputted IP address exists in the telephone number DNS server 210, the telephone number corresponding to the inputted IP address is transmitted to the telephone number DNS server 210 (S411). If the telephone number information corresponding to the inputted IP address does not exist, an error message is transmitted to the telephone number DNS client 200 (S410).

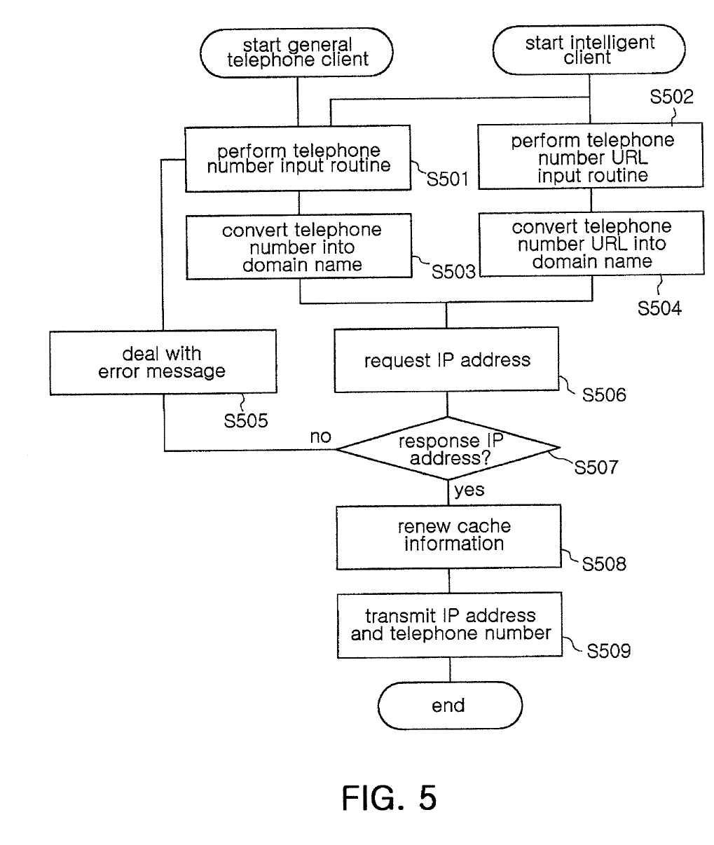

FIG. 5 is a flowchart showing the operation of the telephone number DNS server. The clients of the present invention are divided into an intelligent client and a general telephone client. The intelligent client can provide a telephone number URL input routine and a telephone number input routine, while the general telephone client can provide a telephone input routine.

With reference to FIG. 5, the operation of each client is described. In the case of the general telephone client, first of all, a telephone input routine is performed (S501). A telephone number inputted through the telephone input routine is converted into a domain name (S503). The converted domain name is formed as an FQDN. The conversion will be described in detail later. Subsequently, the IP address corresponding to the domain name is requested from the telephone number DNS server 210 (S506). The telephone number DNS server 210 transmits a response to the telephone number DNS client 200 through the above described procedure. The telephone number DNS client 200 receives and examines the response (S507). If the response is an IP address, the telephone number DNS client 200 renews cache information with the IP address (S508) and allows the telephone number and the IP address to be used by application programs (S509).

However, if the response is not an IP address but an error message, the error message is dealt with (S505) and, subsequently, the telephone number input routine is performed (S501).

As described above, in the case of the intelligent client, both the telephone input routine and the telephone number URL input routine can be provided. If the telephone number input routine is performed, the description of the operation of the intelligent client is omitted because the operation of the intelligent client is the same as that of the general telephone client. However, if the telephone number URL input routine is performed (S502), the inputted telephone number URL is converted into a domain name (S504). Subsequently, the IP address corresponding to the domain name is requested from the telephone number DNS server 210 (S506). The remaining operation of the intelligent client is the same as that of the general telephone client.

Now, the steps S503 and S504 of converting the telephone number into the domain name and converting the telephone number URL into the domain name are described in detail.

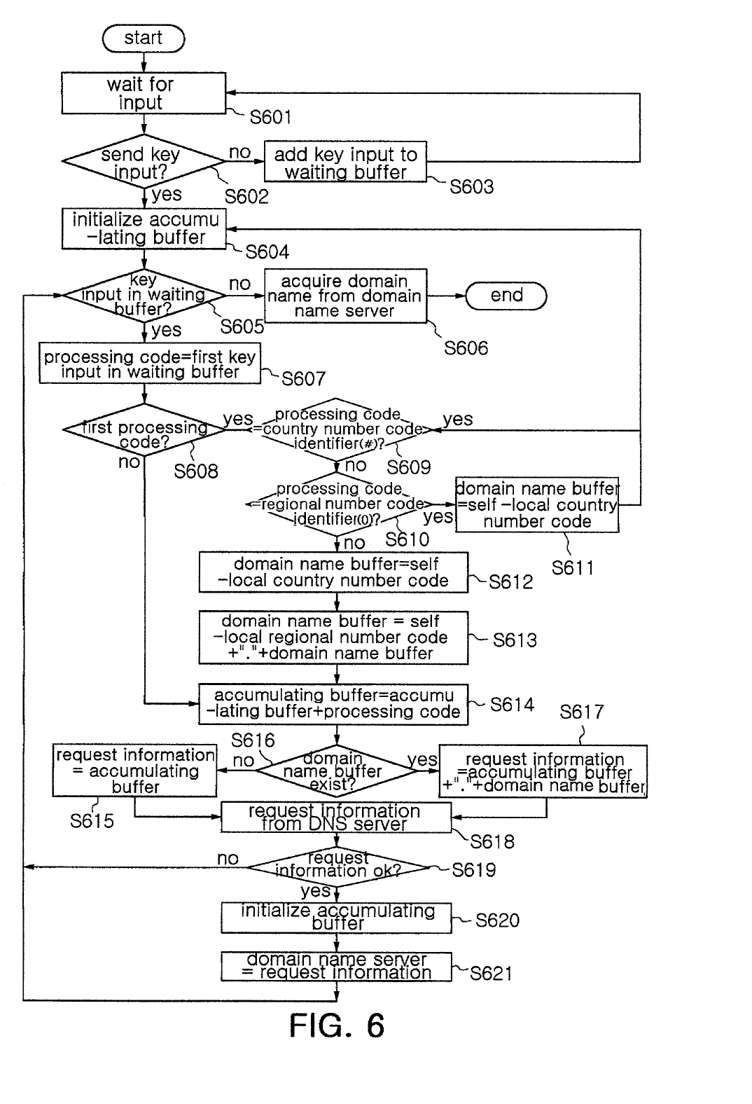

FIG. 6 is a flowchart showing the process of converting a telephone number into a domain name, which illustrates the step S503 of converting a telephone number into a domain name in detail. Referring to FIG. 6, if some key other than an end key is inputted (S602) while the client waits for a key input (S601), the key input is stored in a waiting buffer (S603). In the waiting buffer, key inputs, for this embodiment, inputted telephone numbers, are stored. If, at the step S602, an end key is inputted, the process proceeds to a step S604. In this case, the end key is a random key that indicates the termination of telephone number inputs in the terminal being used on a PSTN, is preferably an existing ‘send key’. The input of the send key is to establish a transfer from the telephone number input routine to a telephone number-into-domain name conversion routine, and the telephone number is converted into a domain name.

Subsequently, variables to be used are initialized (S604), and it is determined whether a key input exists in the waiting buffer (S605). If no key input exists in the waiting buffer, a domain name is acquired from a domain name server (S606) and the process is ended.

However, if one or more key inputs exist in the waiting buffer, a key input in the first buffer of the waiting buffer is fetched as a processing code (S607) and it is determined whether the key input is a key stored in the first buffer (S608). In this case, each of the inputted telephone numbers is stored in waiting buffers in order of a country number code, a regional number code, a telephone exchange number code and a telephone terminal number code, respectively. When a telephone connection is carried out within one country, the country number code can be omitted from the telephone number; and when a telephone connection is carried out within one region, the regional number code can be omitted from the telephone number.

If the key input is the first processing code, it is determined whether the processing code is an identifier that indicates a country number code (S609). If the processing code is the country number code identifier, a key input in a second buffer is dealt with (S604). In such a case, a globally agreed random character, in the present embodiment, “#”, can be selected as the country number code identifier. If the processing code is not the country number code identifier, source and destination telephone numbers exist in the same country. For example, it means that a telephone connection is conducted between Washington and New York without inputting a country number code.

When at step S609 the key input in the first waiting buffer is a country number code identifier, a telephone connection is made between two countries. This is because a country number code is not inputted when a telephone connection is made within one country. When a telephone connection is made between two countries, an input telephone number is inputted to waiting buffers in order of # a country number code, a regional number code, a telephone exchange number code and a terminal number code. The step S609 proceeds to the step S604. It is determined whether a key input exists in the waiting buffer (S605). If the key input exists in the waiting buffer, the key input is eliminated from the first waiting buffer and the next key input is fetched as a processing code (S607). Thereafter, it is determined whether the next key input is a first processing code (S608). Since the first processing code is “#” and the next processing code is a country number code, the process proceeds to a step S614. Subsequently, the next processing code is acquired and stored in the accumulating buffer (S614).

However, if at the step S609 the processing code is a country number code identifier, the process proceeds to the next step S610. If the key input in the first waiting buffer is not a country number code, it means that a telephone connection is carried out within one country. In this case, if the telephone connection is carried out between two different regions, a regional number code is added to the first waiting buffer; while if the telephone connection is carried out within one region, a telephone exchange number is added to the first waiting buffer.

Thereafter, it is determined weather the first processing code is a regional number code identifier (S610). If the first processing code is the regional number code identifier, a self-local country number code is acquired and stored in a domain name buffer (S611), and the input key in the next waiting buffer is dealt with. In this case, the process proceeds to the step S604 again, and is carried out as described above.

However, if at the step S610 the first processing code is not the regional number code identifier, a self-local country number code is acquired and stored (S612). Subsequently, ‘the self-local regional number code +. (dot)+the domain name buffer data’ is acquired and stored (S613). Thereafter, the processing code is added to the accumulating buffer (S614).

In the meantime, if the key input is a first processing code at the step S608, the procedure proceeds to the step S614. Subsequently, after at the step S614 the accumulating buffer is dealt with, it is determined whether data exist in the domain name buffer (S616) so as to create request information. If data exist in the domain name buffer, there is created request information that consists of ‘accumulating buffer data +. (dot)+domain name buffer data’ (S617). If data do not exist in the domain name buffer, there is created request information that consists of only the accumulating buffer data (S615) and the request information is requested from the DNS server (S618). Thereafter, a request result is examined (S619). If a domain name does not exist, the process proceeds to the step S605 to deal with the key input in the next waiting buffer; if the domain name exists, the accumulating buffer is initialized (S620) and the request information is stored in the domain name buffer (S621). Subsequently, it is determined whether a key input exists in the next waiting buffer, the key input is dealt with. That is, the key input is fetched as a processing code, and dealt with as described above. After the inputted destination telephone number is fully dealt with and a domain name stored in the present domain name buffer is acquired. Accordingly, the inputted telephone number is converted into the domain name.

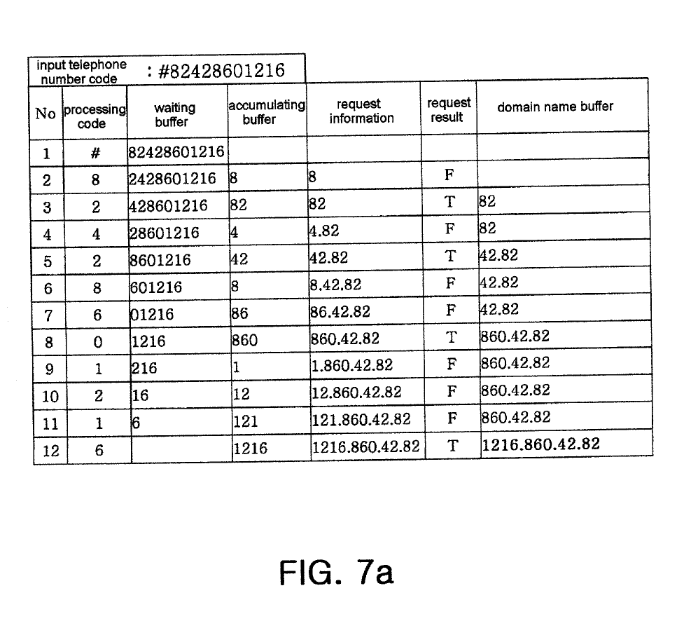

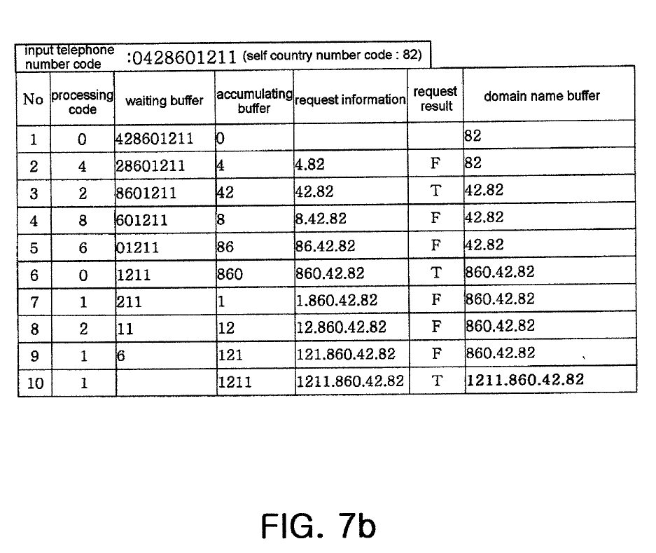

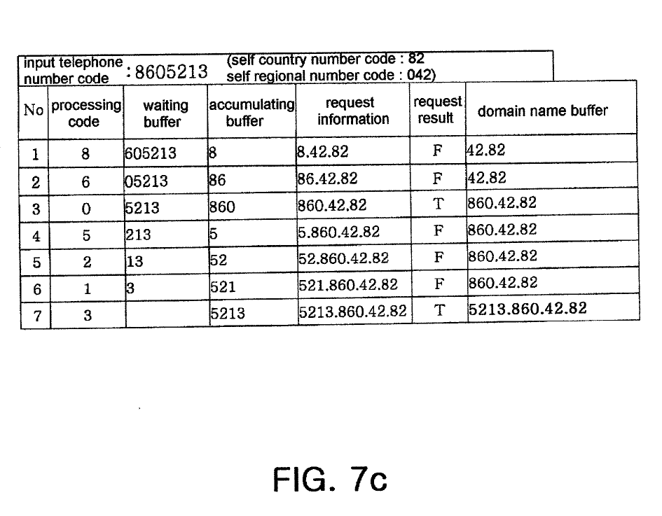

FIGS. 7a to 7c are tables showing an example of the process of converting a telephone number into a domain name shown in FIG. 6. With reference to FIGS. 6 and 7a to 7c, the example is described F in more detail.

FIG. 7a is a table showing a telephone number-into-domain name converting routine when an inputted telephone number is #82428601216. First of all, if a client inputs #82428601216 as a destination telephone number when conducting a telephone connection from a foreign country to Korea, this telephone number (key inputs) is stored in a waiting buffer. Subsequently, if a send key is inputted (S602), an accumulating buffer is initialized (S604). After it is determined whether a key input exists in the waiting buffer (S605), the telephone number inputs are retrieved one by one as a processing code (S607). In the example, since the first processing code is a country number code, that is, “#”, the process proceeds to the step S604 of initializing the accumulating buffer. Thereafter, the next key input “8” is retrieved as a processing code (S607). Since this key input is a second key input, the processing code “8” is stored in the accumulating buffer (S614). Thereafter, it is determined whether a domain name exists (S616). If the domain name does not exist, the accumulating buffer data “8” are stored as request information (S615) and the request information is requested from the DNS servers (S618). As a result, the domain name does not exist, so the next key input is dealt with (S605).

The next key input “2” is retrieved as a processing code (S607). Since the processing code “2” is not a first processing code, the processing code “2” is stored in the accumulating buffer (S614). In this case, a new value created by adding the processing code “2” to the present accumulating buffer data “8” is stored in the accumulating buffer. Accordingly, “82” is stored in the accumulating buffer (S614). Since “82” does not exist in the domain name buffer, “82” is stored as request information (S615) and the request information is requested from the DNS server (S618). Since the domain corresponding to “82” exist in the telephone number DNS shown in FIG. 3, the present accumulating buffer is initialized (S620). The request information is stored in the domain name server (S621). Accordingly, the domain “82” is stored in the domain name server (S621).

Subsequently, the next number, that is, the regional code “4” is retrieved as a processing code (S607). Thereafter, the steps similar to the forming of the domain “82” are repeated, so “42” is stored in the accumulating buffer (S614). In this case, since the domain “82” already exists in the domain name buffer, request information becomes 42.82 and 42.82 is stored in the domain name buffer (S621). Thereafter, the next number, that is, the telephone exchange number “8” is retrieved (S607). Domains “860.42.82” are acquired by repeating the above-described steps and, finally, a domain name “1216.860.42.82” is acquired.

In brief, as described above and shown in FIG. 3, in the telephone DNS of the present invention, the country number of telephone numbers are converted into top level domains of domain names and the region number, telephone exchange numbers and telephone terminal numbers of the telephone numbers are resolved into the lower levels domains of the domain names. As a result, the country number “82” of the inputted telephone number is converted into the top domain of a domain name, the regional number “42” of the inputted telephone number is converted into the second level domain of the domain name, the telephone exchange number “860” of the inputted telephone number is converted into the third level of the domain number and the telephone terminal number “1216” of the inputted telephone number is converted into the fourth level domain of the domain name, thereby acquiring a domain name “1216.860.42.82”.

FIG. 7b is a table showing a destination telephone number-into-domain name resolution routine when a telephone connection is conducted within Korea, differently from FIG. 7a. When FIG. 7b is compared with FIG. 7b, every part is the same except a country number code part. With reference to FIG. 7a, the destination telephone number-into-domain name conversion routine is described in detail. In FIG. 7b, an inputted destination telephone number is 0428601211. As described above, since the telephone connection is conducted within Korea, a country number code “82” is omitted.

A first processing code is a regional code, that is, “0”, so a self-local country number code is stored in a domain name buffer (S611). In such a case, each client recognizes country and regional number codes to which it belongs. Accordingly, if a telephone exchange number code is first inputted as a destination telephone number, the client forms a top level domain with its local country number (S611) and an inputted number is retrieved as a processing code (S607).

As a result, a domain “82” is formed in the domain name buffer, and a telephone exchange number “4” is retrieved as a processing code (S607). The subsequent steps are similar to the steps of FIG. 7a, so the description of the steps is omitted. A domain name “1211.860.42.82” is acquired through the steps of FIG. 7b.

FIG. 7c is a table showing a destination telephone number-into-domain name conversion routine when a telephone connection is conducted within one region. When FIG. 7c is compared with FIG. 7b, every part is the same except a regional number code part. In FIG. 7c, an inputted destination telephone number is 8605213. If a telephone exchange number is first inputted, a first processing code becomes the telephone exchange number “8”. In this case, a self-country number domain “82” is formed in a domain name server (S612) and, subsequently, ‘a self-regional number code +. (dot)+self-country number code’ domains are formed in the domain name buffer (S613). As a result, domains “42.82” is formed in the domain name buffer. The processing code “8” is stored in an accumulating buffer. Thereafter, a domain “860” is formed. Finally, a domain name “5213.860.42.82” is acquired.

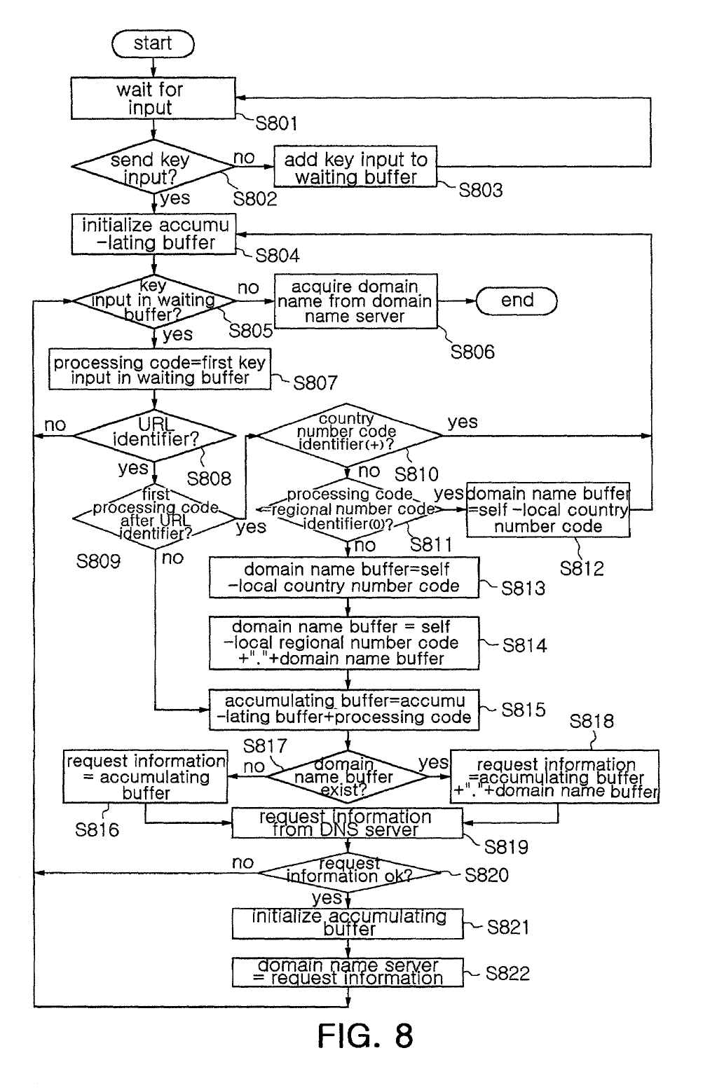

FIG. 8 is a flowchart showing the process of converting a telephone number URL into a domain name, which illustrates the step S504 of converting a telephone number into a domain name in detail (see FIG. 5).

It is determined whether a send key is inputted (S802) while the client waits for a key input (S801). The send key functions the same as the send key of FIG. 6. The input of the send key initiates the process of converting a telephone URL into a domain name. If some key other than the send key is inputted at the step S801, the key input is stored in a waiting buffer (S803). If the send key is inputted, the accumulating buffer is initialized (S804) and it is determined whether a key input exists in the waiting buffer (S805). If no key input exists in the waiting buffer at the step S805, a domain name is acquired from a domain name buffer (S806) and the procedure is ended.

However, if the key input exists in the waiting buffer at the step S705, a first key input is fetched from the waiting buffer as a processing code (S807) and it is determined whether the processing code is a telephone number URL identifier (S808). The telephone number URL can be represented in various forms such as “phone:”, “sip:”, “h323” or the like. If at the step 808 yes, it is determined whether the processing code after the telephone number URL identifier is a process code in the first waiting buffer (S809). In this case, the inputted telephone URL is stored in the waiting buffer in order of a URL identifier, a country number code, a regional number code, a telephone exchange number code and a telephone terminal number code. In the case of a telephone connection within one country, the input of the country number code can be omitted; in the case of a telephone connection within one region, the input of the regional number code can be omitted. For example, the telephone number URL may have a form of sip:042860121.

Subsequently, if at the step S809 the processing code is a processing code in the first waiting buffer, it is determined whether the processing code is a country code identifier key input (S810). If the processing code is a country number code identifier key input, the process proceeds to the step 805 and the key input in the second waiting buffer is dealt with. In such a case, a globally agreed random character, in the present embodiment, “+”, can be selected as the country code identifier to be distinguished from the country code identifier “#” of FIG. 6. If the processing code is not the country number code identifier, source and destination telephone number URLs exist in the same country. For example, it means that a telephone connection is conducted between Washington and New York.

If the key input in the first waiting buffer is the country number code identifier “+” at step S810, a telephone connection is made between two countries. This is because the country code should be first inputted after the URL identifier when a telephone connection is conducted between two countries. Accordingly, the input telephone number is inputted to waiting buffers in order of ‘+ a country number’, ‘a regional number, a telephone exchange number and a terminal number after the URL identifier. If at step S810 the key input in the first waiting buffer is the country number code identifier “+”, the process proceeds to the step S804. Subsequently, it is determined whether a key input exists in the waiting buffer (S805). If the key input exists in the waiting buffer, the key input is eliminated from the first waiting buffer, and the next key input is fetched as a processing code (S807). Thereafter, after it is determined whether the next key is the URL identifier, it is determined whether the next key input is a first processing code (“S809). Since the first processing code is already is a country number code identifier “+”, the next processing code becomes the country number code and the procedure proceeds to a step S614.

However, if at the step S609 the processing code is a country number code identifier “+”, the process proceeds to the next step S811. If the key input in the first waiting buffer is not a country number code, it means that a telephone connection is conducted within one country. In this case, if the telephone connection is carried out between two different regions, a regional code comes first in the waiting buffer; while if the telephone connection is carried out within one region, a telephone exchange number comes first in the first waiting buffer.

Subsequently, it is determined weather the first processing code is a regional n number code identifier (S811). If the first processing code is the regional number code identifier key input, a self-local country number code is acquired and stored in a domain name buffer (S812), and the procedure proceeds to the step S804 to deal with the input key in the next waiting buffer. The step S804 and subsequent steps are carried out as described above.

However, if at the step S811 the first processing code is not the regional number code identifier, a self-local country number is acquired and stored in the domain name buffer (S813). Subsequently, ‘the self-local regional number code +. (dot)+the domain name buffer data’ is acquired and stored (S814). Thereafter, the processing code is added to the accumulating buffer (S815).

In the meantime, if at the step S809 the key input is the first processing code, the process proceeds to the step S815. Subsequently, after the processing code is stored in the accumulating buffer (S815) and the accumulating buffer is dealt with, it is determined whether data exist in the domain name buffer (S817) so as to create request information. If data exist in the domain name buffer, there is created request information that consists of ‘the accumulating buffer data +. (dot)+the domain name buffer data’ (S818). If data do not exist in the domain name buffer, there is created request information that consists of only the accumulating buffer data (S816) and the request information is requested from the DNS server (S819). Thereafter, a request result is examined (S820). If a domain name does not exist, the procedure proceeds to the step S805 to deal with the key input in the next waiting buffer; if the domain name exists, the accumulating buffer is initialized (S821) and the request information is stored in the domain name buffer (S822).

Subsequently, it is determined whether a key input exists in the waiting buffer, the key input is dealt with. That is, the key input is retrieved as a processing code, and dealt with as described above. After the inputted destination telephone number URL is fully dealt with and a domain name stored in the present domain name buffer is acquired. Accordingly, the inputted telephone number is resolved into the domain name.

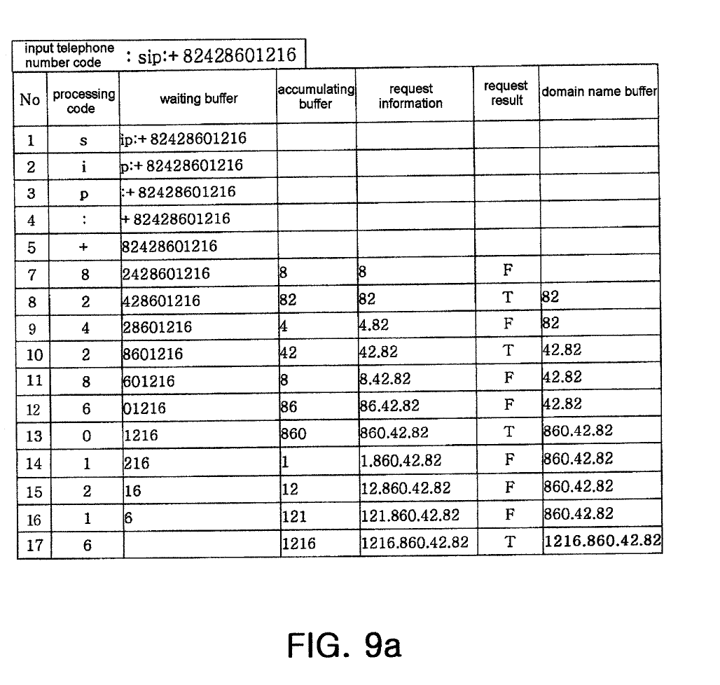

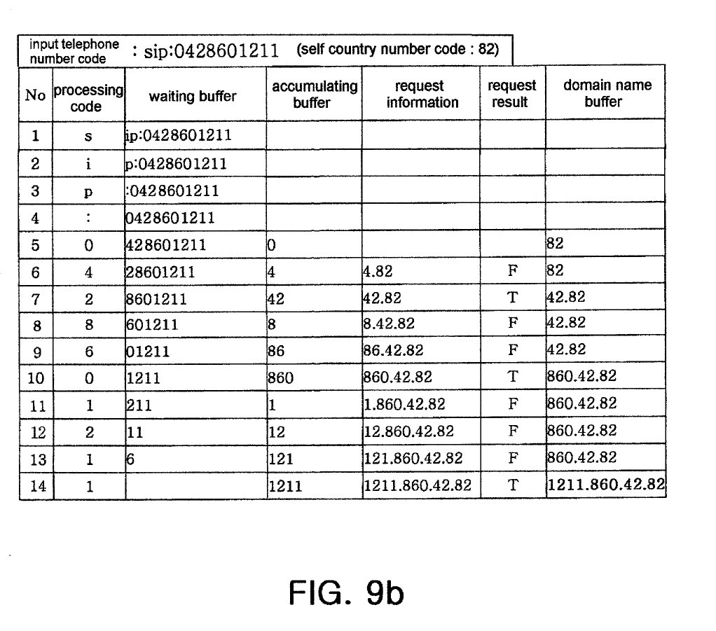

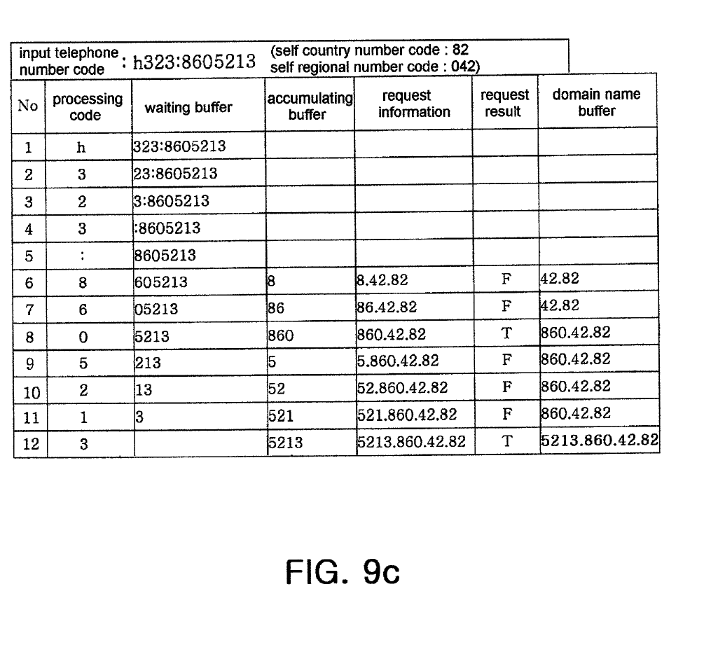

FIGS. 9a to 9c are tables showing an example of the process of converting a telephone number URL into a domain name. With reference to FIGS. 8 and 9a to 9c, the example is described in more detail.

FIG. 9a is a table showing a telephone number URL-into-domain name conversion routine when an inputted telephone number is sip:+82428601216. First of all, if a client inputs sip:+82428601216 as a destination telephone number URL when conducting a telephone connection from a foreign country to Korea, this telephone number URL (key inputs) is stored in a waiting buffer. Subsequently, if a send key is inputted (S802), an accumulating buffer is initialized (S804). After it is determined whether a key input exists in the waiting buffer (S805), the telephone number inputs are fetched one by one as a processing code (S807). Subsequently, the URL identifier is recognized (S808) If at the step S808 yes, the process proceeds to the step S804 of initializing the accumulating buffer because in the example, the first processing code after the URL identifier is a country number code, that is, “+”. Thereafter, the next key input “8” is fetched as a processing code (S807). Since this key input is not the URL identifier but a second key input after the URL identifier, the processing code “8” is stored in the accumulating buffer (S815). Thereafter, it is determined whether a domain name exists (S817). If the domain name does not exist, the accumulating buffer data “8” are stored as request information (S816) and the request information is requested from the DNS servers (S819). As a result, the domain name does not exist, so the next key input is dealt with (S805).

The next key input “2” is fetched as a processing code (S807). Since the processing code “2” is not a first processing code after the URL identifier, the processing code “2” is stored in the accumulating buffer (S815). In this case, at the step 815, a new value created by adding the processing code “2” to the present accumulating buffer data “8” is stored in the accumulating buffer. Accordingly, “82” is stored in the accumulating buffer (S815). Since “82” does not exist in the domain name buffer, “82” is stored as request information (S816) and the request information is requested from the DNS server (S819). Since the domain corresponding to “82” exist in the telephone number DNS shown in FIG. 3, the present accumulating buffer is initialized (S821). The request information is stored in the domain name server (S822). Accordingly, the domain “82” is stored in the domain name server (S822).

Subsequently, the next number, that is, the regional code “4” is fetched as a processing code (S807). Thereafter, the steps similar to the forming of the domain “82” are repeated, so “42” is stored in the accumulating buffer (S815). Meanwhile, since the domain “82” already exists in the domain name buffer, request information becomes 42.82 (S818) and 42.82 is stored in the domain name buffer (S822). Thereafter, the next number, that is, the telephone exchange number “8” is fetched (S807). Domains “860.42.82” are acquired by repeating the above-described steps and, finally, a domain name “1216.860.42.82” is acquired.

In brief, as described above and shown in FIG. 3, in the telephone DNS of the present invention, the country number of telephone numbers are converted into top level domains of domain names and the region number, telephone exchange numbers and telephone terminal numbers of the telephone numbers are converted into the lower levels domains of the domain names. As a result, the country code “82” of the inputted telephone number is converted into the top domain of a domain name, the regional number “42” of the inputted telephone number is converted into the second level domain of the domain name, the telephone exchange number “860” of the inputted telephone number is converted into the third level of the domain number and the telephone terminal number “1216” of the inputted telephone number is converted into the fourth level domain of the domain name, thereby acquiring a domain name “1216.860.42.82”.

FIG. 9b is a table showing a destination telephone number URL-into-domain name conversion routine when a telephone connection is conducted within Korea, differently from FIG. 9a and FIG. 9c is a table showing a destination telephone number URL-into-domain name conversion routine when a telephone connection is conducted within one region.

FIGS. 9b and 9c are similar to 7b and 7c, so the description of a converting process is omitted.

The above-described telephone number #82428601216 and the above-described telephone number URL are only examples to explain the present invention, so the present invention is not limited to the examples.

In addition, according to the present invention, all the terminal numbers can be converted into domain names, and the input of the numbers can be carried out in various forms.

As described above, in accordance with the present invention, a worldwide unique telephone number can be converted into a worldwide unique domain name and the telephone number can be a corresponding IP address by using the telephone number DNS of the present invention. Although in the specification and drawings of the present invention the construction and operation of a client and servers for providing VoIP on the Internet connected to PSTNs, the present invention is applicable to interconnection between VoIP protocols, an existing telephone system such as a media gateway and an interconnection gateway.

Accordingly, in accordance with the present invention, an existing DNS having been used on the Internet is employed, so expansibility is superior, interconnection between different kinds of terminals can be facilitated, and management burden is reduced due to its distributional characteristics. Additionally, the telephone number DNS system of the present invention can be used without hindering a server being operated, and services can be provided with minimal resolution by a client.

Furthermore, in the telephone number DNS system of the present invention, identifier using existing telephone numbers are provided, so the telephone number DNS system can be applied to higher applications, such as Internet facsimile systems, Internet automatic telephone response system and the like.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed:

1. A telephone number domain name system on the Internet network, providing a connection between IP address and telephone number on the Internet network offering Voice over Internet Protocol (VoIP) services and being connected to Public Switched Telephone Network (PSTN), comprising:
a client, having
a telephone number input section for receiving a telephone number,
a domain name conversion section for converting said received telephone number into a domain name, and
an address request section for requesting an Internet protocol (IP) address corresponding to said converted domain name; and
a telephone number domain server, having
an address search section for searching an IP address corresponding to an IP address request of said address request section,
an address response section for transmitting said searched IP address to said client

2. The telephone number domain name system on the Internet network of claim 1, wherein said client further comprises a first storage section storing said converted domain names

3. The telephone number domain name system on the Internet network of claim 2, wherein said domain name conversion section searches said first storage section, and retrieves a domain name existing in said firs storage section and converts said received telephone number into said domain name if said domain name corresponding to said received telephone number exists in said first storage section.

4. The telephone number domain name system on the Internet network of claim 1, wherein said telephone number domain server further comprises a second storage section storing said searched IP addresses.

5. The telephone number domain name system on the Internet network of claim 4, wherein said address search section searches said second storage section and retrieves an IP address if said IP address exists in said second storage section.

6. The telephone number domain name system on the Internet network of claim 1, wherein said client further comprises,
a telephone number URL input section for receiving a telephone number URL,
a telephone number URL-domain name conversion section for converting said received telephone number URL into a domain name and providing said converted domain name to said address request section.

7. The telephone number domain name system on the Internet network of claim 1, further comprising at least one higher server than said telephone number domain server.

8. The telephone number domain name system on the Internet network of claim 1, wherein said converted domain name is formed by combining a country number domain, a regional number domain, a telephone exchange number domain and a telephone terminal number domain using said received telephone number.

9. The telephone number domain name system on the Internet network of claim 8, wherein said converted domain name is formed by converting a country number of said received telephone number into a top level domain, a regional number of said received telephone number into a second level domain, a telephone exchange number of said received telephone number into a third level domain, and a telephone terminal number of said received telephone number into a fourth level domain.

10. An operating method of a telephone number domain name system on the Internet, said telephone number DNS including a plurality of telephone terminal clients and a plurality of servers for processing said client's requests, said telephone terminal clients and servers being connected through one or more public switched telephone networks (PSTNs) and the Internet to provide Voice over Internet Protocol (VoIP) services, comprising the steps of:
inputting a destination telephone number to a client;
converting said inputted telephone number into a domain name;
requesting an IP address corresponding to said converted domain name from one or more servers;
searching for said requested IP address; and
transmitting said searched IP address to said client.

11. The operating method of a telephone number domain name system on the Internet of claim 10, wherein said step of converting said telephone number into a domain name comprises the steps of:
setting a country number of said destination telephone number as the top level domain of the domain name;
setting a regional number of said destination telephone number as the second level domain of the domain name;
setting a telephone exchange number of said destination telephone number as the third level domain of the domain name; and
setting a telephone terminal number of said destination telephone number as the bottom level domain of the domain name.

12. The operating method of a telephone number domain name system on the Internet of claim 11, further comprising the step of recognizing said country number to which the client belongs and setting said country number as said top level domain of said domain name if said country number of said destination telephone number is not inputted.

13. The operating method of a telephone number domain name system on the Internet of claim 10 or 11, further comprising the step of recognizing said regional number to which the client belongs and setting said regional number as the second level domain of said domain name if said regional number of said destination telephone number is not inputted.

14. The operating method of a telephone number domain name system on the Internet of claim 10, wherein said telephone number is a telephone number URL.

15. The operating method of a telephone number domain name system on the Internet of claim 14, wherein said step of converting said telephone number URL into a domain name comprises the steps of:
setting a country number of said destination telephone number as the top level domain of said domain name;
setting a regional number of said destination telephone number as the second level domain of said domain name;
setting a telephone exchange number of said destination telephone number as the third level domain of said domain name; and
setting a telephone terminal number of said destination telephone number as the bottom level domain of said domain name.

16. The operating method of a telephone number domain name system on the Internet of claim 10, wherein said server comprises client's server and a plurality of higher servers.

17. The operating method of a telephone number domain name system on the Internet of claim 16, wherein said step of searching for said IP address is carried out by searching said client's server and said high server for said IP address.
